(19) United States
(12) Patent Application Publication
(10) Pub. No.: US 2009/0245696 A1
(43) Pub. Date: Oct. 1, 2009

(54) Method and apparatus for building compound-eye seeing displays

(75) Inventors: Chang Yuan, Vancouver, WA (US); Scott J. Daly, Kalama, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 12/080,169

(22) Filed: Mar. 31, 2008

(51) Int. Cl. G06K 7/00

(52) U.S. Cl. 382/312; 382/100

(57) ABSTRACT

A display includes an integrated imaging sensor and a plurality of pixels. The imaging sensor integrated within the display includes a plurality of individual sensors each of which provides an output. The output of each of the individual sensors is processed to generate an image. The resulting image has a greater depth of field than the depth of field of one of the individual sensors.

### CROSS-REFERENCE TO RELATED APPLICATIONS

Not applicable.

### BACKGROUND OF THE INVENTION

The present invention relates to a display with an imaging sensor.

There exists “seeing” displays that can sense viewers. Such “seeing” displays utilize optical sensors to capture images of the scene in front of the display. The images are analyzed for making the display interact with the viewers.

One technique to construct a seeing display is to mount external video cameras in front of or on the boundary of the display system. Unfortunately, the external cameras have a limited narrow field of view, relatively complex installation requirements, relatively large form factor, and dependency on additional computation and devices (e.g. computers).

Another technique to construct a seeing display utilizes 3D depth cameras to capture the 3D depth map of objects in front of the display in real time. These cameras emit infra-red lights toward the scene in front of the display and estimate the 3D depth of the objects based on the time-of-flight of reflected lights. However, the pixel resolution of the generated depth images is relatively low. Also, the 3D depth cameras are relatively expensive.

Another technique to construct a seeing display uses embedded optical sensors in or behind the panels for sensing the viewers in front of the display. However, the optical sensing performance of these sensors is limited by their relatively short sensing range of less than 1 inch and their relatively low image quality.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIGS. 1A and 1B illustrate a conceptual design of optical sensors.

FIGS. 2A and 2B illustrate a general design of the optical sensing module.

FIGS. 3A-3C illustrate various orientations of optical sensors.

FIG. 4 illustrates design of optical sensing modules for LCDs.

FIG. 5 illustrates optical sensing process based on the LC lens.

FIG. 6 illustrates reconstructing HR color image from compound eye LR images.

FIG. 7 illustrates a 3D depth image.

FIG. 8 illustrates estimate HR depth image from LR compound eye images.

FIG. 9 illustrates estimation of HR color and depth images for LCD.

FIG. 10 illustrates shape and depth from focus.

FIG. 11 illustrates interaction capability for the seeing display.

### DETAILED DESCRIPTION OF PREFERRED EMBODIMENT

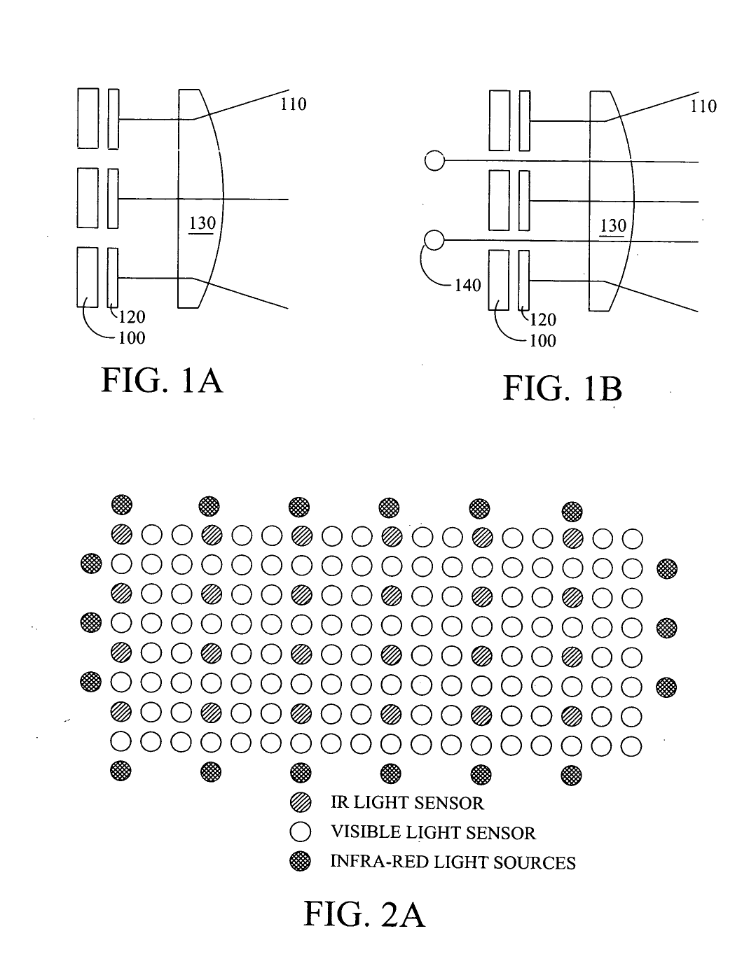

The seeing capability for a display system is enabled by integrating a compound-eye optical sensing module into the frontal surface of the display. The optical sensing module contains a large array of optical sensors. Each optical sensor consists of four components, as shown in FIG. 1. Referring to FIG. 1A, a photoreceptor 100 generates electronic images as the response to the photonic signals 110 that reaches it surface. The number of pixels in the photoreceptor may range from only 1×1 to 16×16, or any suitable arrangement. A transparent optical film based filter 120 is attached to the frontal side of each photoreceptor and allows primarily visible light or infra-red light to pass through. A convex micro lens 130 gathers lights through a small aperture and refracts them toward the photoreceptor 100. Referring to FIG. 1B, an optional infra-red (IR) light source 140 projects IR lights towards the scene in front of the display.

The optical path through the optical sensor is also shown in FIG. 1. The light rays 110 reflected from the scene in front of the display first pass through the micro lens 130, then the optical filter 120, and finally reaches the photoreceptors 100. Due to the convex shape of the micro lens 130, the parallel light rays 110 will converge at the photoreceptors 100. As the micro lens 130 has a small aperture and small refraction index, the amount of light that reaches the photoreceptor 100 is limited. This results in a possibly dark and blurry image with the limited view of the scene.

The seeing display largely depends on the lights reflected from the scene in front of the display. The lighting conditions in front of the display may be quite different. For example, the ambient light in outdoor environments is very strong, resulting in bright images in the visible light range and over-saturated images in the IR range. On the other hand, the indoor environments are usually darker, in which the visual light images become under saturated while the IR image sensors become more reliable.

In order to accommodate different ambient lighting conditions, different kinds of sensors or their combination may be used. A visual light sensor is primarily sensitive only to the visible lights and generates either grayscale or RGB color images, as shown in FIG. 1(a). A visible light filter that primarily allows only visible lights to pass through is attached to the photoreceptor. The IR light source is not necessarily in this sensor. Referring to FIG. 1(b), an infra-red light sensor is primarily sensitive only to the IR lights and generates grayscale images. Similarly, an optical film that primarily allows only IR lights to pass through is attached to the photoreceptor. As the IR lights from the viewing environment may not be strong enough, an IR light source, e.g. LED array, may be placed behind the photoreceptor and projects more lights to the outside world, eventually increasing the IR lights reflected from the scene.

The optical sensors can be adjusted to suit particular needs. The sensor may be changed from one kind of sensor to another kind of sensor. Also, a combination of different kinds of sensors may be included within the same display. The micro lens can be made thinner and moved closer to the photoreceptors, which decreases the focal length of sensor. Inversely, the lens can be made thicker and moved farther from the photoreceptors in order to increase the focal length. The strength of the IR light source can be modified to adapt to the viewing environment. A stronger IR light, although consuming more energy, increases the sensing range.

The individual optical sensor is a sensing unit that observes a small part of the scene and typically senses a blurry image. The compound eyes found in arthropods, such as dragonflies and honey bees, combine thousands or more of these sensing units to generate a consistent view of the whole scene. In analogy to the natural compound eyes, an optical sensing module is preferably designed to integrate a plurality or tens or hundreds or thousands or more optical sensors.

Instead of constructing a completely separate imaging device, the sensing module may be integrated into the display system by replacing part of the pixel array on the frontal surface with optical sensors and including additional electronic components interconnected to the sensors. Integration of optical sensors with the display device does not substantially impair the main display functionality, does not substantially reduce display quality, nor does it substantially increase the number of defects in the device. A number of techniques may be used to reduce noticeable decreases in display quality. For example, one technique includes the sensors being constructed in a form factor generally the same size as or smaller than the sub-pixels (red, green, or blue) on the display surface, so that they will not be noticed by the viewers at a normal viewing distance. Another technique includes each sensor replacing a partial portion of a sub-pixel which will tend to have minimal effects on the display quality. For back lighting based display devices, the colors of the sub-pixels are selected so that the reduced light in that color is least noticeable by viewers. For example, the blue sub-pixel is selected for placing the sensors as human eyes are least sensitive to blue (associated with a majority of the blue pixels and/or associated with blue pixels to a greater extent than the other pixels). The optical components of the sensors are made transparent, so that the lights occluded by the sensors are reduced. Also, the sensors may only emit IR lights if needed, which do not interfere with the rendered content in the visible light range. A minimal density of the embedded optical sensors is selected as long as the captured image is above the minimal pixel resolution. In other words, as long as the density or the number of optical sensors is enough for the application, no more sensors are necessary.

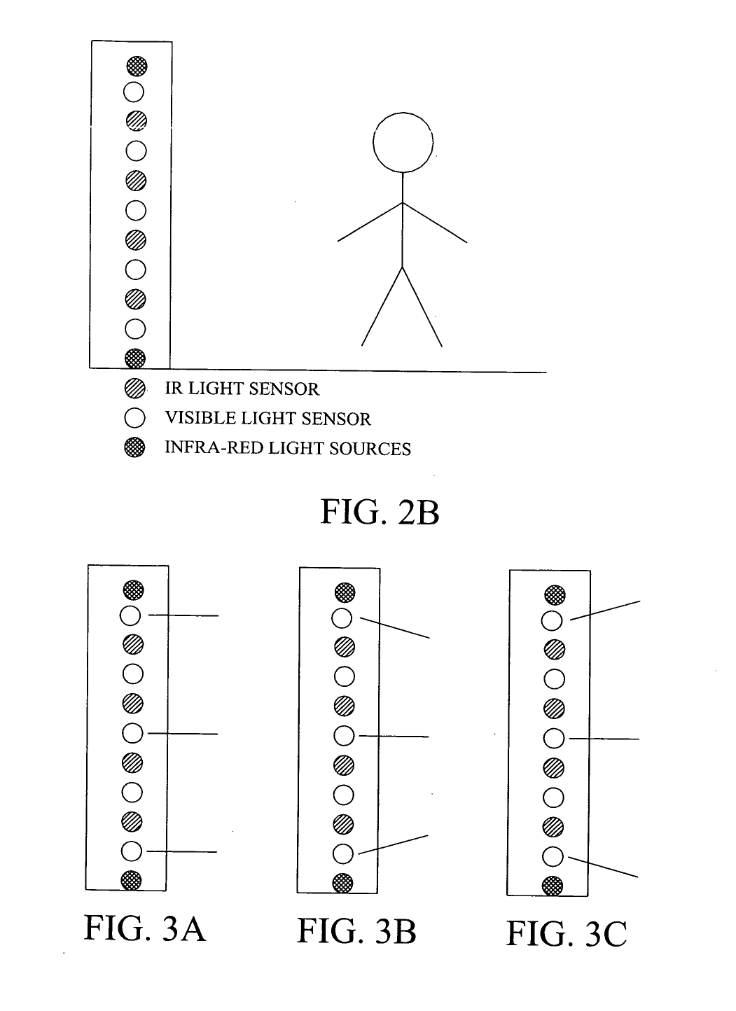

The general design of the optical sensing module for various kinds of display systems is illustrated in FIG. 2. In FIG. 2, the sizes of sensors and light sources are exaggerated for illustration. Both visible light and IR light sensors are embedded into the pixel array on the frontal surface of the display. The optical sensors are preferably evenly distributed across a majority of, or all of, the pixel array. Different kinds of sensors may be distributed intermittently to cover the same field of view, similar to the interlaced pixels in the video display.

Each IR light sensor, or groups of sensors, also includes an IR light source that is placed behind the photoreceptor. Additional IR light sources may also be embedded in the boundary of the display device. These IR light sources project IR light towards the objects in front of the display and increase the light reflected by the objects, thus enabling the sensing module to see a larger range in front of the display and to capture brighter images.

Flexible configuration of compound-eye optical sensors can be selected for various applications:

(1) Besides the even-space layouts shown in FIG. 2, the optical sensors can be also distributed in other layouts. For example, the sensors can be placed in hexagonal grids in analogy to a bee's honeycomb, as the hexagonal shape spans the maximum area with the minimum expenditure of materials. Moreover, the layout may be random, or with any configuration.

(2) The density of optical sensors can also be made adaptive to the viewing environment. For example, the viewers are more likely to face the central regions of the display screen, especially for a large display. Therefore, more optical sensors can be placed in the central regions while the rest of the areas on the screen are embedded with less optical sensors.

(3) The percentage of visible light or IR light sensors over the whole set of sensors may be adjusted. For a display mainly used in outdoor environments, it is preferable to embed more visible light sensors in the display surface as sun light introduces much IR aberration. For a display used mainly in dark environments, more IR light sensors will improve the sensed image as the IR lights can still be seen in a dark environment.

(4) The focal length of each optical sensor can be adjusted. If the optical sensors are made with the same specification, only a certain depth range of the scene is in focus. When the focal length of optical sensors is adjusted by using different micro lens and moving the photoreceptors, the compound-eye sensing module can see the scene at different focal lengths at the same time. This adjustment makes the captured images appear sharp at all the depth ranges and is inherently suited for the estimation of 3D depth images.

(5) The orientations or optical axes of optical sensors can be adjusted, as shown in FIG. 3. The optical axis of an optical sensor is determined by the shape of micro lens and the orientation of the photoreceptor. If the micro lens is etched to a skewed shape and the photoreceptor is rotated with a controlled angle, the optical axis of the sensor can be changed. The orientations of the sensors can be adjusted from their standard configuration in which all the sensors have parallel optical axes. The sensors can be rotated such that their optical axes converge in front of the display. This assists in the generation of sharp images while reducing the field of view. Inversely, the sensors with diverging optical axes gain a larger field of view while losing certain amount of image sharpness. This makes the compound-eye module act as a large virtual lens in a planar, convex, or concave shape.

Also, the optical sensing module can fit to the flexible shape of the display for flexible and foldable display screens in various 3D shapes, including planar, spherical, cylindrical, etc. As each sensor is small enough to deform together with its adjacent sub-pixels, the seeing functionality of flexible display is not substantially affected by the shape deformation.

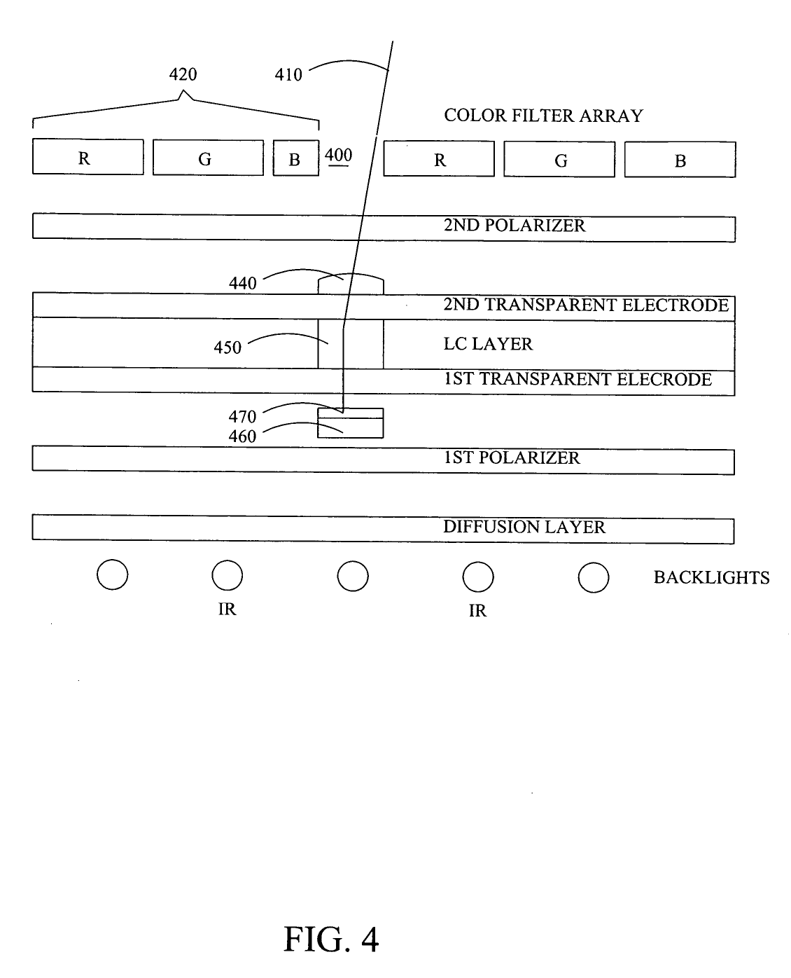

If the display system is known to be made of LCD panels, a specialized design for embedding the optical sensors into the LCD screen may be applied. The specialized design takes advantages of the common structure of LCD devices and modifies the layers within a LCD, as shown in FIG. 4. In particular, the modification may include the following elements, starting from the back side of the LCD.

(1) An IR light source may be added to the same layer as the fluorescent backlights. The light emitted by IR light sources becomes substantially uniformly distributed after passing the diffusion layer. This will help in collecting more light reflected from the surface of the outside world.

(2) A CMOS sensor may be placed between the 1st polarizer and 1st transparent electrode layer. This sensor generates electronic images as the response to the lights coming from the outside world. The sensor is made smaller than a sub-pixel, so the light from the backlight forming the displayed image that would be occluded by sensor will not be visually noticeable.

(3) A transparent polymer electrode is attached to the 2nd transparent electrode layer to generate an LC lens. This additional electrode is etched to a parabolic or wedged shape and applies the voltage to the LC layer. It is controlled independently and is active when the sensor needs to capture the images.

(4) Circuitry may be added to synchronize the electrode and CMOS sensor. The electrode is activated in synchronization with the CMOS sensor so that the light passing through LC lens reaches the sensor at the same time in a pre-defined frequency. For example, the circuitry applies the charges 30 times per second, so that the captured images are updated in 30 frames per second.

(5) A small hole may be cut from the one of the RGB color filters, so that external lights may pass through the layers and reach the CMOS sensor. A preferred color is blue as human eyes are less sensitive to the loss of blue light. The area of this hole can be less or around 50% of that of the original sub-pixel color filter.

The LC lens created by the parabolic or wedged electrode may be part of the design. When a voltage is charged by the electrode, the LC molecules become untwisted to different directions, and generate a LC lens. The LC lens acts as a prism created within the LC layer and transmits and refracts the light. The light passing through the LC lens will be bent towards the photoreceptor in the back side.

A favorable property of the LC lens is that its focal length is electrically controllable by varying voltages from the electrode. The change of focal length is also continuous under continuously varying voltage. Despite the variable focal length, the LC layer does not change their physical shape and keeps a thin form factor. This is an advantage over the traditional lenses; the latter may need to change their physical shape and occupy more physical space to achieve different focal lengths.

The electrically controllable LC lens may be used to create flexible optical sensing components. When all the LC lenses are created by the same voltage, the compound-eye sensing module works as a virtual large lens with a controlled focal length. On the other hand, the voltage of different electrodes can be evenly selected within a range so that the generated LC lenses have smoothly increasing focal lengths. The corresponding sensors may observe a variably controlled depth of focus and keep every object within this range in focus. In general, it is preferred that these sensor arrays have a resulting depth of focus of greater than 5 mm and more preferably greater than 10 mm. More particularly, it is preferred that the sensor arrays are suitable for focusing on content that is ¼ display height, and more preferably ½ display height, and more preferably a display height or more away.

Another property of the LC lens is that it will not substantially leak the backlights to the outside world. In traditional LCDs, the light passing through the 1^{st} polarizer cannot pass the 2^{nd} one if the LC molecules are untwisted. In this case, the molecules are untwisted when the voltage is applied to create the LC lens, so only the external lights will come in, while the backlights will not be leaked out. The voltage should be selected to reduce the leakage of the backlight.

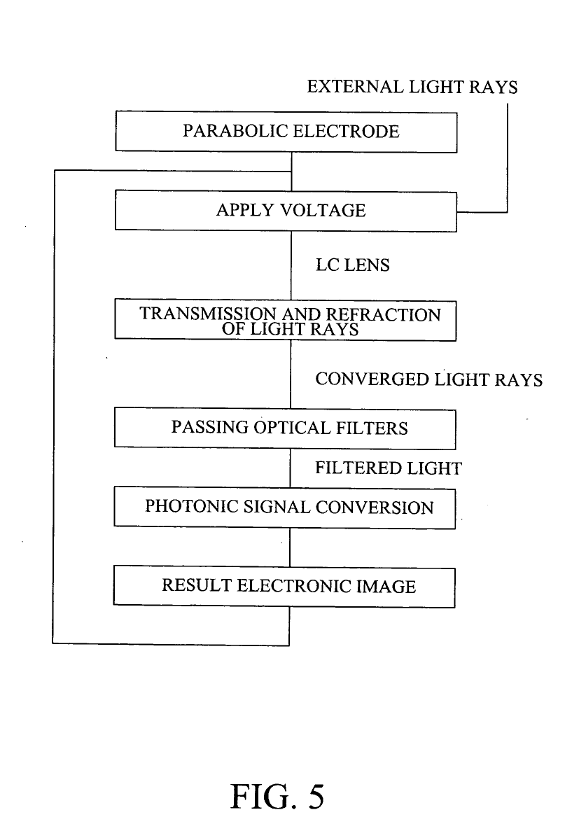

The optical sensing process based on the LC lens is summarized in FIG. 4 and FIG. 5. The light rays 410 first pass through the holes 400 cut from the color filters 420 and then reach the LC layer 430. As controlled by the additional circuitry, the parabolic electrode 440 applies a voltage to the LC molecules and generates a LC lens 450. The light rays pass through the LC lens 450 and converge at the photoreceptor 460. An optical filter 470 allows only a certain range of light, either visible or IR, to pass through. The photoreceptor 460 receives the filtered light and converts photonic signals to electronic images.

The compound-eye optical sensing module preferably utilizes a large number of dispersed optical sensors to capture the images of the scene in front of the display. The images captured by each sensor are not suitable to be used directly for analyzing the whole scene. Such images have low pixel resolution due to the small number of photoreceptors, ranging from one single pixel to 16 by 16 pixels. Furthermore, the small aperture and low convergence of the micro lens tend to result in a blurry image.

A technique to reconstruct a high-resolution (HR) color image from these low-resolution (LR) images is desirable. After the reconstruction, the original set of small-aperture and blurry LR images collected from the dispersed sensors is registered and converted into a HR image that captures the whole scene in front of the display with wider field of view and sharper details. Besides the HR color image that captures the appearance of the viewing environment, a depth HR image is also computed for sensing the 3D structure of the scene in front of the display. This reconstruction process is designed to simulate the biological process within the brains of arthropods with compound eyes.

For LCD devices, a reconstruction technique may take advantage of the LC lens. A series of different voltages may be applied to the LC layer to generate a series of LC lenses with different focal lengths. The captured LR images are processed by a shape/depth from focus technique and converted into a color and depth image simultaneously.

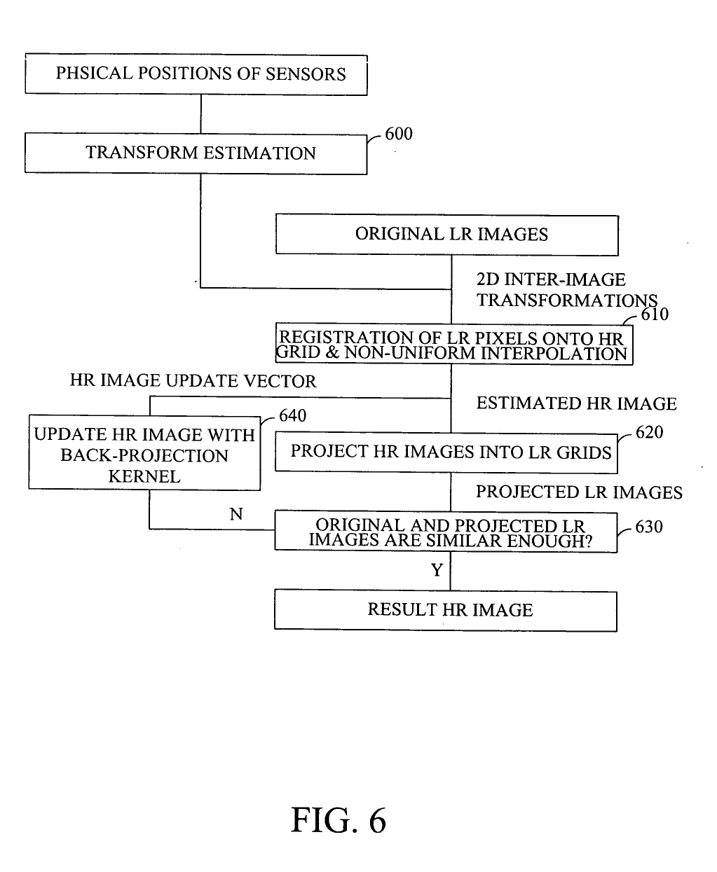

The reconstruction of HR color images based on compound-eye images can be formulated as a multi-image super-resolution problem. Those images from the visible light sensors may be used in the estimation. An iterative reconstruction process is illustrated in FIG. 6.

The first step of the reconstruction process is to compute 2D geometric transformations 600 between the LR images, which are used to register the LR images to the HR grids later. The 2D perspective transformation is a commonly selected inter-image transformation for registering the pixels between two LR images. It is computed based on the known 3D positions of compound-eye sensors and the parameters of each sensor, including focal length and image centers.

Since each sensor in the compound-eye sensing module ideally sees only a small different part of the scene (if the LC lens is perfect), the HR image that captures the whole scene is created by registering multiple LR images to the HR image grids 610. With one LR image taken as the reference, all the other LR images are projected to the HR image grids 620 based on the reference image, by the 2D inter-image transformations. As each pixel in the HR image may correspond to multiple pixels in LR images, the corresponding value of the HR pixel is determined by non-uniform interpolation of LR pixels 630. Since the LC-lens will generally be of poor quality, it will end up collecting light over a wider angle than needed for depth of focus issues. Essentially, each capture sensor can be regarded as having a very large point spread function (PSF).

The registered HR image is usually blurry and contains much noise and artifacts. The true HR color image is recovered by an iterative image restoration process. The current estimate of HR image is projected into the LR image grid and generates a number of projected LR images. The differences between the original and projected LR images are evaluated and used to update the HR image 640 based on a back-projection kernel approach. The process continues until the image difference is small enough or the maximum number of iterations has been reached.

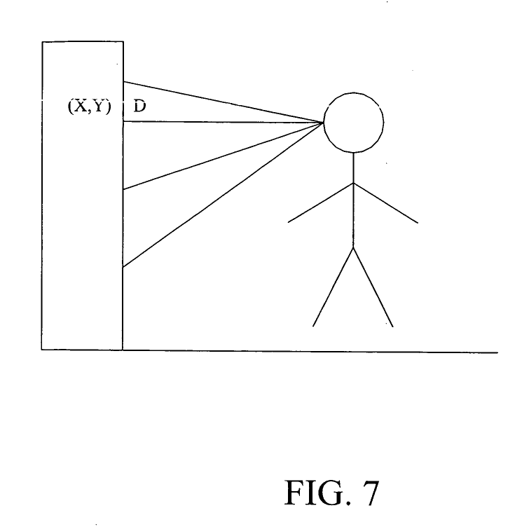

As the scene in front of the display is observed by multiple sensors at different positions at the same time, the 3D depth cues of the scene are inherently embedded in the LR images. The 3D scene structure can be computed based on the multi-view LR images. A depth image is defined in the same resolution of the HR color image, where the value for each pixel p(x, y) is the 3D depth d, or the perpendicular distance from the point on the display screen to a point in the scene, as shown in FIG. 7. The display screen serves as a reference plane in the 3D space with its depth as zero. The depth of any scene point is larger than zero, as all the points lie on one side of the sensing module.

The depth image (x, y, d) serves as a compact representation of the 3D scene. Given a pixel (x, y) and its depth value d, a 3D point can be uniquely located in the scene. The depth image can also be converted into other 3D representations of the scene, including 3D point clouds and mesh structures.

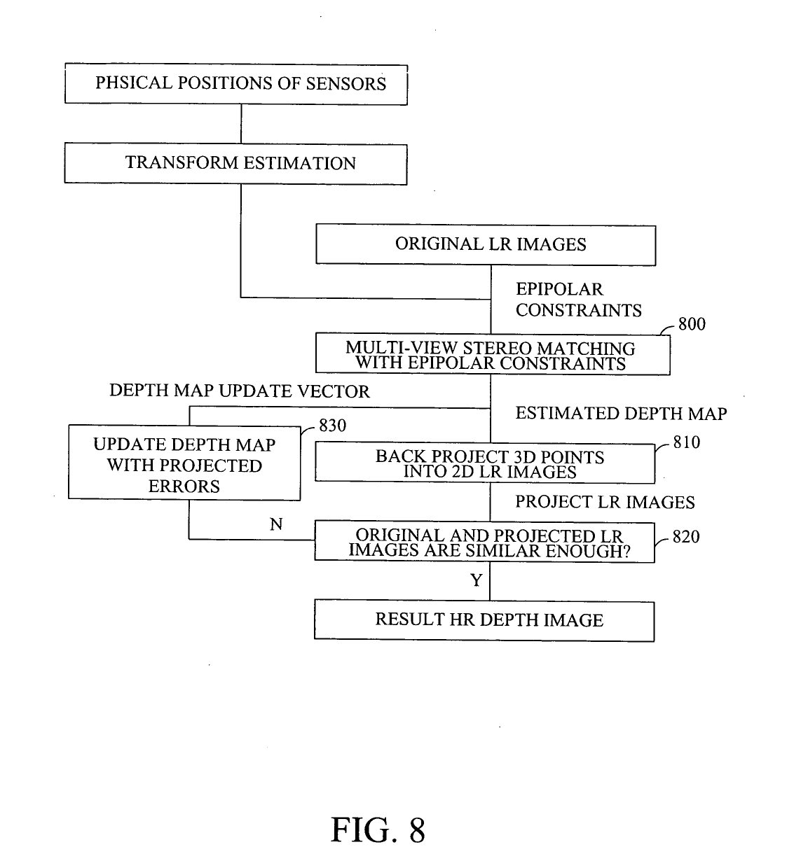

The depth image is estimated by an iterative optimization technique as shown in FIG. 8. The technique uses the 3D positions and orientation of compound-eye sensors, and the LR images captured by both visible light and IR light sensors.

The 3D position of a scene point can be determined by intersecting the optical rays in the 3D space. As shown in FIG. 7, a 3D point can be uniquely determined by intersecting two rays. In practice, this intersection is implemented as the stereo matching of 2D image pixels. A pair of pixels in different images are said to be matched if the difference between their adjacent regions is below a pre-defined threshold. Once a pair of two pixels is matched across two images, the depth is computed by intersecting the two corresponding optical rays in the 3D space.

This technique may utilize an inter-image transformation, called the epipolar constraint 800, to match the images. Given a pixel in one image, the epipolar constraint generates a 2D line in the other image. The stereo matching process searches along the 2D line and finds the pixels with minimal matching difference.

A HR depth image is estimated by matching all pairs of LR images. Then the 3D points corresponding to the estimated depth image is projected back 810 to the 2D images. Similar to the method for color images, the difference between the original and projected LR images are evaluated 820 and used to update 830 the HR depth image, until the difference converges to a small value.

The above two reconstruction techniques are suitable for the compound-eye sensing module integrated into all kinds of display devices. For the LCD devices, there is an additional feature of electrically controllable LC lens to estimate the color and depth of the images for LCD images at the same time by utilizing this feature.

A good characteristic of the LC lens is that its focal length can be accurately controlled by the varying voltage. When a series of voltage values is applied to the LC molecules, the compound-eye optical sensors capture a series of images of the scene with varying focal lengths. This is equivalent to taking photos of the scene with a multi-focus lens at the same viewpoint.

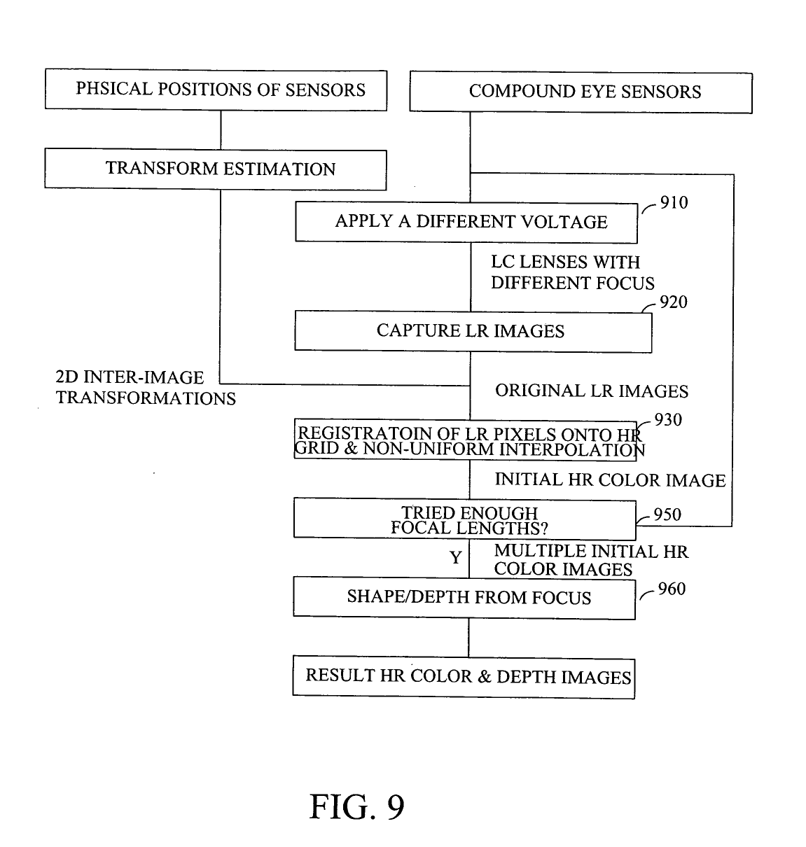

The reconstruction technique starts by taking multiple shots of the scene with varying focal lengths, as shown in FIG. 9. At each time, a different voltage 910 is applied to the parabolic electrodes that are in contact with the LC layer, resulting in LC lenses with a different focal length. The LR images captured 920 by the compound-eye sensors are registered into an initial HR image 930, similarly to the method for general display devices. Due to the short depth of field and small aperture of compound-eye sensors, the initial HR image may be blurry and contains noise and artifacts. Instead of recovering the true HR color images at this step, one may generate a number of initial HR color images 950 for later processing.

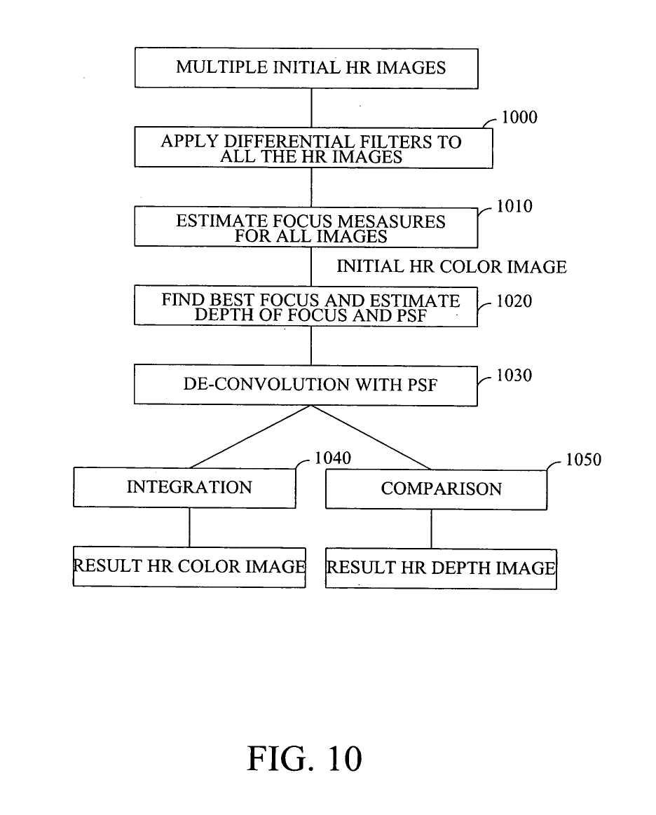

After trying enough focal lengths 950, the system obtains a set of initial HR color images, each of which is the image of the same scene generated with a different focal length. Due to the short depth of field of compound-eye sensors, the initial HR image may be partially or completely out-of-focus. Namely, part of the image may be in focus while the rest of the image is blurry. In the extreme case, the whole image is out-of-focus and blurry. The set of initial HR images are fed into a Shape/Depth from Focus process 960, which is illustrated in FIG. 10.

Despite the out-of-focus regions in the initial HR images, these images still provide information about the true scene. The Shape from Focus and Depth from Focus techniques are applied to recover the underlying color and depth images of the scene. The out-of-focus region in an image may be characterized as the convolution of the point spread function (PSF) with the corresponding part of the true scene. Multiple out-of-focus regions will provide cues for solving the PSF based on the known focal length and the depth of field.

Estimation of the color and depth images is inherently related to each other. For a certain region in the image, it is only possible to obtain the in-focus image of that region when the depth of focus is also known. On the other hand, once an image region is clear and in focus, the depth of focus can be determined by this region. The color and depth images can be estimated jointly by the same process.

The first step is to apply differential filters 1000 to the images and then computes the image characteristics 1010. For example, Laplacian filters can be applied to multiple images in order to find the sharp edges. Then the best focus is found by comparing all the filtered images 1020. For a certain image region, if one image is selected as the best focus, the depth of focus of this image is also computed. The corresponding regions in all the other images are considered as being convoluted with a point spread function (PSF). The in-focus versions of the same region are estimated by de-convolution with the PSF 1030 in the image domain or inverse filtering in the frequency domain. After de-convolution with the PSF, the originally out-of-focus regions become clear and sharp as long as the right depth and PSF are found.

The HR color image 1040 is computed by integrating the multiple de-convoluted images. In this image, every part of the scene is in focus. In contrast, the HR depth image 1050 is obtained by comparing the original and de-convoluted HR color images and selecting the best depth of focus for each image pixel.

All the three image reconstruction techniques are highly parallel as independent operations applied to each pixel. Therefore, the reconstruction process can be accelerated by dividing the large task for the whole image into multiple sub-tasks for each pixel on multi-core CPUs or GPUs (graphics processing units). After efficient implementation and optimization, the reconstruction methods can run in real time or close to real time, which allows the real-time seeing and interaction ability of the display.

The compound-eye sensing module enables the display to see the scene in front of it in real time. This seeing capability adds another capability to the display, namely the interaction capability. Based on the color and depth images of the scene, the display is capable of interacting with the viewers and also the viewing environment. This section introduces the applications of the seeing display to the interaction capability.

It is natural that the viewers want to control the display while observing the visual content at the same time. The seeing capability enables the display to react to the viewers' presence and motion, and allow the viewers to control the display without using any devices, such as mouse, keyboard, remote control and other pointing devices. The viewers can also control the display remotely without touching the display.

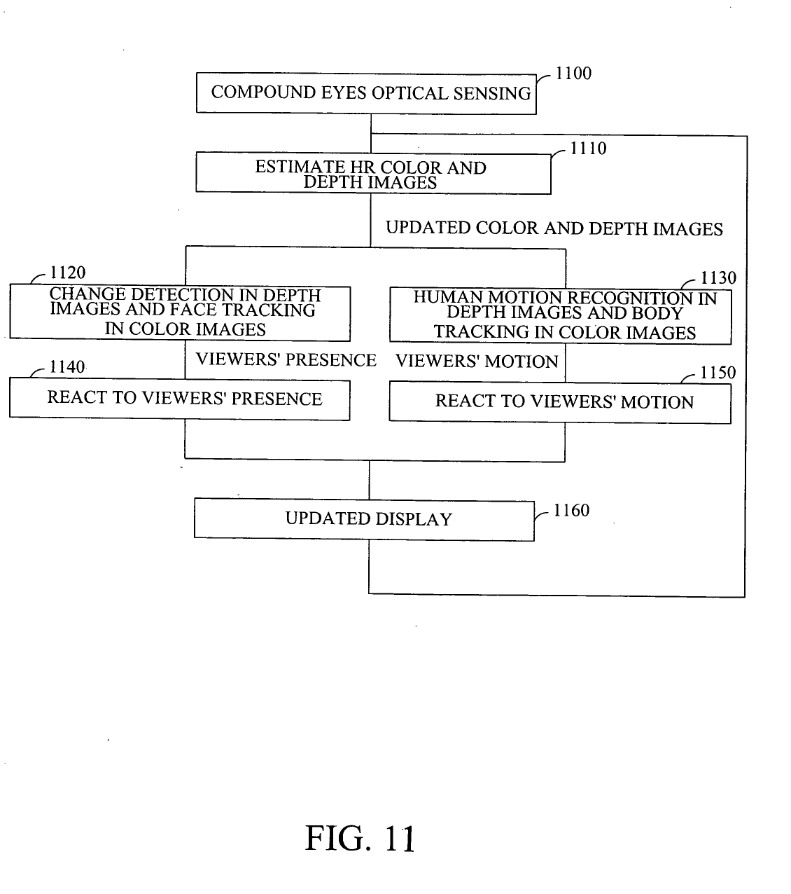

The interaction process between the seeing display and the viewers are illustrated in FIG. 11. The compound-eye sensing module 1100 captures new color and depth images 1110. Then both images are analyzed to infer the changes 1120, 1130 in viewers' presence 1140 and motion 1150. The display reacts to these changes by updating 1160 the display.

When the viewers enter the viewing environment, there exists difference between the depth images captured in consecutive time instants. The different areas within the image indicate the presence of a new viewer. Otherwise, if a viewer stays still in the viewing environment, he/she will not be detected in the depth images. The face detection and tracking method is applied to the color image to find the viewers.

The display will react to the viewers' presence. For example, the display is turned off to save energy consumption. When a viewer enters the environment, the sensor observes his/her entrance and will turn the display to show the content for the viewer. Another example is that an additional image window will be created on the screen for a new viewer and will be destroyed when the viewer leaves the environment.

The viewers' motion is also recognized by analyzing both color and depth images. The human motion and gesture are recognized in the 3D depth images. When the viewer does not have any motion, his 2D body shape is tracked in the color images.

The display will react to the viewers' motion. The viewers can control the display by making hand or finger gestures. For example, the viewers can move both hands in opposite directions to enlarge an image, which is indeed a remote “multi-touch” function. Another example is that the image window created by a specific viewer will follow the viewer if he/she moves in front of the display.

Similarly, the compound-eye module enables the display to see the viewing environment and interact with it. For example, the ambient light conditions can be estimated from the color images. If the ambient light is low, the brightness of the display is also reduced to ensure that the viewers feel comfortable. In another example, when a display observes a lamp in the scene, a virtual reflection of the lamp can be shown on the display to increase the viewers' sense of immersion.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A display with integrated imaging sensor comprising:
(a) said display including a plurality of pixels;
(b) said imaging sensor said integrated within said display and including a plurality of individual sensors each of which provides an output;
(c) processing said output of each of said individual sensors to generate an image;
(d) wherein said image has a wider field of view than the field of view of one of said individual sensors;
(e) wherein said image has a greater depth of field than the depth of field of one of said individual sensors.

2. The display of claim 1 wherein said imaging sensor includes a photo-receptor, a filter, and a micro lens per each imaging sensor element (pixel).

3. The display of claim 2 wherein said filter is a visible light filter.

4. The display of claim 2 wherein said filter is an infra-red light filter.

5. The display of claim 4 wherein said display further includes an infra-red light source.

6. The display of claim 1 wherein said imaging sensors are interspersed in said display pixel array.

7. The display of claim 1 wherein each of said sensors is no larger than a corresponding sub-pixel of said display.

8. The display of claim 1 wherein the majority of said sensors are associated with blue pixels of said display.

9. The display of claim 1 wherein a greater density of said sensors are in the central region of said display than the peripheral region of said display.

10. The display of claim 1 wherein the optical axes of a plurality of said sensors are non-parallel.

11. The display of claim 10 wherein said sensors exhibit the characteristics of a convex lens with the focal length equal to or larger than the half display height.

12. The display of claim 10 wherein said sensors exhibit the characteristics of a concave lens.

13. The display of claim 5 wherein said infra-red light source is at the same layer of said display as fluorescent backlight.

14. The display of claim 1 wherein said sensor includes a lens constructed from liquid crystal material.

15. The display of claim 1 wherein said sensors are arranged in such a manner to sense a three dimensional structure in front of said display.

16. The display of claim 15 wherein said sensors have a different focal length based upon different voltages applied to a liquid crystal layer of said display.

17. The display of claim 1 wherein said display reacts to the presence of a viewer.

18. The display of claim 17 wherein said display reacts to gestures of said viewer.

19. The display of claim 18 wherein said display reacts to a gesture of moving hands in opposite directions.

20. The display of claim 19 wherein said moving hands in opposite directions results in enlarging an image on said display.

21. The display of claim 15 wherein said display generates a three dimensional depth image of the scene.

22. The display of claim 15 wherein said display generates a color image of the scene.

23. The display of claim 21 wherein said depth image is a color image.

24. A display with integrated imaging sensor comprising:
(a) said display including a plurality of pixels;
(b) said imaging sensor said integrated within said display and including a plurality of individual sensors each of which provides an output;
(c) processing said output of each of said individual sensors to generate an image;
(d) wherein said image has a greater depth of field than the depth of field of one of said individual sensors;
(e) wherein said image has a depth of field greater than 5 mm.

25. The display of claim 24 wherein said image has a wider field of view than the field of view of one of said individual sensors.

26. The display of claim 24 wherein said image has a depth of field greater than 10 mm.

27. The display of claim 26 wherein said image has a depth of field greater than ¼ height of said display.

28. The display of claim 27 wherein said image has a depth of field greater than ½ height of said display.

29. The display of claim 28 wherein said image has a depth of field greater than one height of said display.

30. A display with integrated imaging sensor comprising:
(a) said display including a plurality of pixels;
(b) said imaging sensor said integrated within said display and including a plurality of individual sensors each of which provides an output;
(c) processing said output of each of said individual sensors to generate an image;
(d) wherein said image has a greater depth of field than the depth of field of one of said individual sensors.
